(19) United States
(12) Patent Application Publication
(10) Pub. No.: US 2006/0251551 A1
(43) Pub. Date: Nov. 9, 2006

(54) Apparatus and method for ozone gas distribution

(76) Inventor: Brian Johnson, Benicia, CA (US)

Correspondence Address: C. Bart Sullivan, 1543 Sherman Dr., Benicia, CA, 94510, US

(21) Appl. No.: 11/124,710

(22) Filed: May 9, 2005

(51) Int. Cl. B01J 19/08

(52) U.S. Cl. 422/186.07

(57) ABSTRACT

An apparatus and method to distribute ozone is described. In one embodiment, one or more ozone systems are in communication with a control center. The central control center receives ozone quality and delivery data from the ozone systems. The control center processes the ozone quality and delivery data to determine the amount and type of ozone dispensed. The ozone quality and delivery data is also used to generate ozone consumption data used to determine the cost of the ozone gas dispensed to the customer. In one embodiment, the control center generates an ozone usage bill based on the amount of ozone consumed. The control center also may remotely manage the one or more ozone systems such that if a customer exceeds a billing threshold, the control center may turn off the one or more systems. In another embodiment, the one or more ozone systems may be responsive to an allocation processing system that controls the amount of ozone dispensed via a key code.

### BACKGROUND OF THE INVENTION

1. Field of the Invention

Embodiments of the present invention generally relate to ozone generators and more specifically to flat plate corona discharge ozone generators and ozone gas distribution.

2. Description of the Related Art

Generally, ozone is unstable but recognized as one of the strongest commercially available oxidant and disinfectant. For example, ozone is often used in water treatment for color reduction, odor control, mircofloculation and disinfection of microogranizms, in petrochemical industry for converting hydrocarbons such as olefins into aldehydes, keytones, carboxylic acid, and is often used for microbial control and food safety in food processing as well as other uses.

Ozone is currently generated using several different techniques. One such ozone generation technique involves producing ozone by passing oxygen though a flat or annular gap between two electrodes separated by a dielectric. A high voltage AC voltage is applied across the electrodes to generate an electric field that provides a high-energy corona discharge therebetween. Oxygen (O₂) is passed between the plates through the corona discharge. Some oxygen molecules passing through the corona discharge are split and recombined into a trivalent oxygen molecule (O₃), i.e., ozone gas.

While ozone has become a major chemical agent for use in many industries, unfortunately, ozone cannot be stored for any length of time without reverting to oxygen. Therefore, ozone must be produced on-site to provide ozone in sufficient quantities to be effective for use in a particular process such as oxidation and disinfection. Often, ozone generators are procured as part of an end user's capital equipment to provide ozone on-site. Maintenance of such ozone generation equipment generally is factored into the cost of procuring an ozone system. Generally, either the end user, the seller, and/or a third party maintains on-site ozone generation equipment. Unfortunately, conventional ozone systems are often custom assemblies. Any change to the amount of ozone needed by the system means that the end user must make changes to the capital equipment. As capital equipment may be expensive, it is often difficult for an end user to procure the additional capacity. Thus, unless the end user is cognizant of the growth of their ozone gas needs, conventional ozone generation and supply may be at best adequate for the end user's needs or may require the purchase of additional ozone generation equipment, even for modest increases in ozone consumption.

Therefore, what is needed is a method and apparatus to provide ozone gas efficiently and economically that allows an end user to match ozone generation consumption with need without procuring unnecessary ozone generation equipment.

### SUMMARY OF THE INVENTION

One embodiment of the present invention is an ozone gas dispensing system. The ozone gas dispensing system includes one or more ozone systems, each deployed at one or more ozone dispensing locations, an ozone measurement system configured to generate ozone dispensing data in response to the amount of ozone dispensed by at least one of the one or more ozone systems. The ozone gas dispensing system also includes a controller configured to process the ozone dispensing data and control the one or more ozone systems, and a communication system configured to allow the controller, the ozone measurement system, and the one or more ozone systems to communicate via one or more communication links.

Another embodiment of the present invention is an ozone gas dispensing system. The ozone gas dispensing system includes an ozone generator and an ozone measurement device coupled to an ozone output of the ozone generator. The ozone gas dispensing system also includes a communication apparatus configured to facilitate communication between the ozone gas dispensing system and a control center. The ozone gas dispensing system includes an ozone control device configured to control the amount of ozone dispensed in response to data received from the control center.

Another embodiment of the present invention is a method of dispensing ozone gas. The method includes measuring the amount of ozone gas dispensed, determining the monetary cost for the ozone gas dispensed, and generating a monetary cost bill to issue to an end user of the ozone gas.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the present invention may admit to other equally effective embodiments.

FIG. 1 is a high-level block diagram of an ozone distribution and control system in accordance with embodiments of the invention.

FIG. 2 is a high-level block diagram of the central controller and ozone system from FIG. 1 in accordance with embodiments of the invention.

FIG. 3 is a high-level block diagram of an ozone system in accordance with embodiments of the invention.

FIG. 4 is a high-level block diagram of an ozone generator in accordance with embodiments of the invention.

FIG. 5 is a high-level block diagram of an ozone allocation apparatus in accordance with embodiments of the invention.

FIG. 6 is a high-level flow diagram of a method for billing customers for ozone dispensed in accordance with embodiments of the invention.

FIG. 7 is a high-level flow diagram of a method for dispensing ozone in accordance with embodiments of the invention.

FIG. 8 is a high-level flow diagram of a method for allocating ozone dispensement in accordance with embodiments of the invention.

### DETAILED DESCRIPTION OF THE PREFERRED EMBODIMENT

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

Embodiments of the present invention are described in terms of wireless communication systems such as defined in IEEE 802.11, and networks such as Wireless Local Area Network (WLAN), Wireless Wide Area Networks (WWAN), and other networks utilizing data packet communication such as the Internet. However, it is understood that the present invention is not limited to any particular communication system or network environment.

Portions of the present invention may be implemented using a computer or microprocessor programmed according to the teachings of the present disclosure, as will be apparent to those skilled in the computer art. Moreover, portions of the present invention may be implemented by the preparation of application specific integrated circuits (ASIC) or by interconnecting an appropriate network of conventional component circuits, as will be readily apparent to those skilled in the art based on the present disclosure.

One embodiment of the present invention include a computer program product which is a storage medium (media) having instructions stored thereon/in which can be used to control, or cause, a computer to perform any of the processes of the present invention. The storage medium may include, but is not limited to, any type of disk including floppy disks, mini disks (MD's), optical discs, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling at least a portion of both the hardware of the computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described herein.

The software described herein may use any one of a number of different programming languages. Appropriate software coding can readily be prepared by skilled programmers based on the teachings of the present disclosure, as will be apparent to those skilled in the software art. For example, the program code can be written in PLC code (e.g., ladder logic), a higher-level language such as C, C++, Java, or a number of other languages. While the software described herein may be a standalone program, it is contemplated that such programming may be combined with other programs for use therewith such as an operating system or part of a software module used therein.

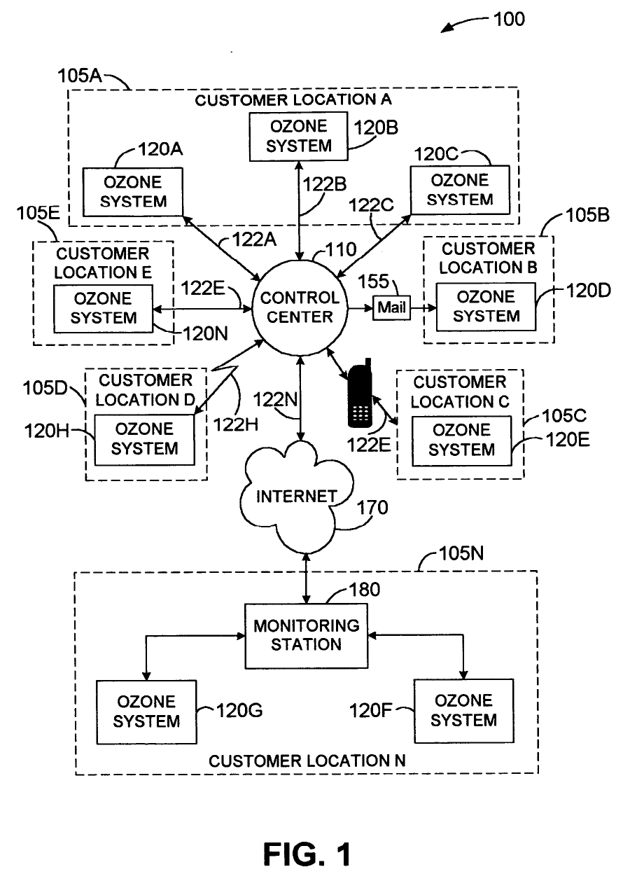

FIG. 1 is a high-level block diagram of an ozone dispensing and control system 100 in accordance with embodiments of the invention. The ozone dispensing and control system 100 includes a control center 110 that is in communication with one or more ozone system 120A-N disposed in ozone end user locations 105A-N. N is defined herein as an nth number. For example, an end user location 105 may be a water treatment plant where the ozone dispensing and control system 100 is used to treat the water. The control center 110 is configured to communicate with the ozone systems 120 using a variety of communication links 122. For example, as illustrated in FIG. 1, the control center 110 may be in communication with one or more ozone systems 120 via wirelessly communication link 122H, via a telephone line communication link 122E, via the Internet 170 using a communication link 122N, and the like, or using virtually any communication medium as is known. The control center 110 may be in communication with one or more ozone systems via postal mail 155. The postal mail 155 communication method be virtually any type of mail, facsimile, or other communication method using a hard copy output or medium that delivers instructions from the control center 110 and/or third party to the end user for use by the ozone system 120. For example, the control center 110 may communicate with ozone system 120D via the US postal service and the like. The postal mail 155 allows the end user to dispense ozone without being electronically linked directly to the control center 110. For example, the end user location 105B may be a remote customer industrial waste treatment plant that does not have the ability to use electronic communication, but receives postal mail 155. Herein, for clarity embodiments of the present invention are described in terms of an operator or end user, however it is contemplated that an operator may be a user, a system administrator, third party user, computer tracking system, and include virtually any personnel and machine capable of utilizing data processed by ozone dispensing system and control system 100.

In one embodiment, the control center 110 receives data from the ozone systems 120 as to the corresponding amount and quality of ozone dispensed by the one or more of the ozone systems 120. The control center 110 may also be used to monitor virtually all aspects of the ozone systems 120 such as the efficiency of ozone output, the amount of power used, maintenance performed, customer tampering, and other data that may be used to advantage. The control center 110 also may be used to control the amount of ozone dispensed by the ozone system 120. For example, in response to receiving ozone dispensing data from the ozone systems 120, the control center 110 may transmit an ozone control signal to one or more of the ozone systems 120. The control signal may be used to vary the amount of ozone dispensed based on criteria such as ozone allotment, ozone billing, and end use ozone dispensing requests.

In one case, as described further below, the control center 110 may send a control signal to start or stop dispensing ozone when the end user has exceeded an ozone allotment amount. The control center 110 may also be used to send instructions that are stored by the ozone system for later use. For example, the ozone systems 120 may store the instruction to dispense ozone only during certain time periods. The control center 110 may also send instructions to an end user monitoring station 180. The end user monitoring station 180 may be used to monitor and control one or more ozone systems 120 that are associated with a particular end user location 105. For example, as illustrated in FIG. 1, the end user location 105N may include ozone system 120G and 120F controlled by monitoring station 180. In one embodiment, the monitoring station 180 may be part of the end user's processing control system.

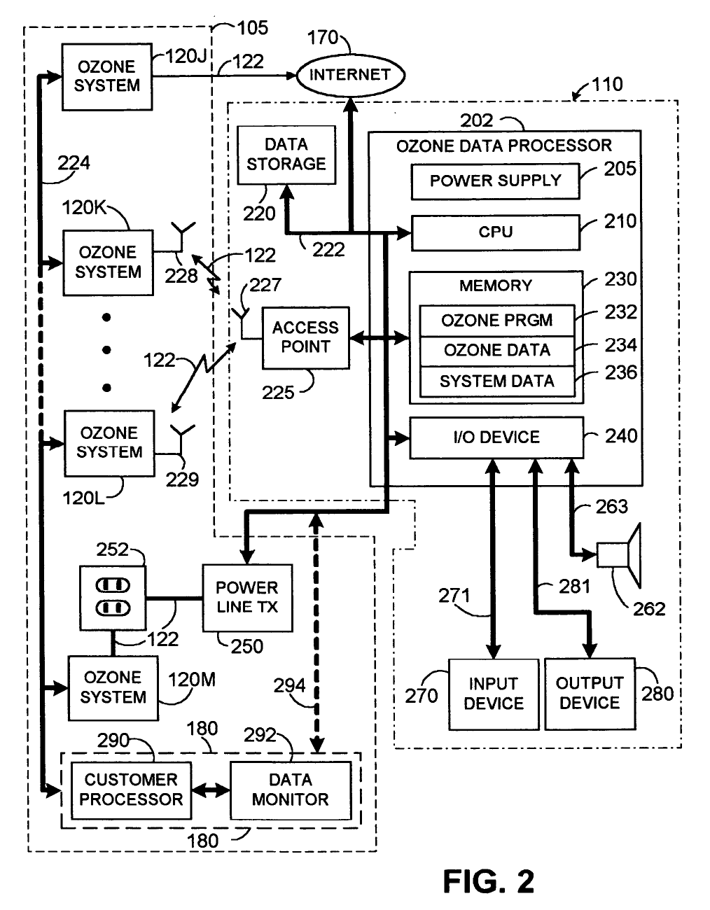

FIG. 2 is a high-level block diagram of the central controller 120 and ozone system 120 from FIG. 1 in accordance with embodiments of the invention. The control center 110 includes an ozone data processor 202, data storage 220, an access point 225, an input device 270, an output device 280, and an alert apparatus 262. Ozone data processor 202 may be powered by power supply 205. Power supply 205 may be virtually any type of power supply device and/or system that may be used to advantage and may use internal and/or external power sources such as batteries, AC-DC converters, and the like. The ozone data processor 202 may be electrically coupled to one or more ozone systems 120 via bus 222. The ozone data processor 202 may be wirelessly coupled to one or ozone systems 120 via the wireless access point 225. For example, the wireless access point 225 includes an antenna 227 configured to wirelessly couple ozone system 120K and the ozone system 120L to the wireless access point 225 via respective antennas 228 and 229 coupled thereto as is known in the art.

For clarity, wireless communication is described herein between ozone systems 120K and 120L and the ozone data processor 202, however it is contemplated that one or more ozone systems 120 may be connected using other connection techniques as are known such as optical connections, and the like, to the ozone data processor 202. In addition, the ozone data processor 202 may communicate with one or more ozone systems 120 using data communication techniques as are known such as Ethernet, USB, firewire (IEEE 1394), serial communication, parallel communication, infrared communication, and the like.

The ozone data processor 202 may be virtually any type of data processing system such as a laptop computer, desk top computer, mainframe, personal data assistant (PDA), and the like, that may be configured to perform embodiments of the present invention to advantage. In one embodiment, the ozone data processor 202 includes Central Processing Unit (CPU) 210, memory 230, and an input/output (I/O) device 240 in communication therewith via bus 222. The bus 222 may be configured to couple data associated with the transmission of data to/from ozone systems 120, for example to/from the ozone data processor 202.

The CPU 210 may be under the control of an operating system that may be disposed in memory 230. Virtually any operating system or portion thereof supporting the configuration functions disclosed herein may be used. Memory 230 is preferably a random access memory sufficiently large to hold the necessary programming and data structures of the invention. While memory 230 is shown as a single entity, it should be understood that memory 230 may in fact comprise a plurality of modules, and that memory 230 may exist at multiple levels, from high speed registers and caches to lower speed but larger direct random access memory (DRAM) chips.

Illustratively, memory 230 may include ozone dispensing/control program 232 that, when executed on CPU 210, controls at least some operations of one or more ozone systems 120. The ozone dispensing/control program 232 may use any one of a number of different programming languages. For example, the program code can be written in PLC code (e.g., ladder logic), a higher-level language such as C, C++, Java, or a number of other languages. While ozone dispensing/control program 232 may be a standalone program, it is contemplated that the ozone dispensing/control program 232 may be combined with other programs such as a database program, operating system, etc.

In one embodiment, memory 230 may include ozone data 234. Ozone data 234 may utilize and be part of a database program found on for example data storage 220 configured to store data associated with the processing and control of ozone output, quality, etc. Ozone data 234 may be processed by ozone data processor 202 to process information associated with the ozone systems 120 including data associated with the amount of ozone dispensed, the cost for the ozone dispensed, the allotment of ozone to be dispensed, the remaining time for ozone allotment, a billing cycle, ozone concentration, ozone quality, and the like.

Memory 230 may also include system data 236. In one configuration, the system data 236 may include the serial number of the ozone systems 120, maintenance schedules, lease data, operation period, operating temperature, supply voltage, supply current, and the like. System data 236 may be used to determine the health of the ozone systems 120 in real-time. For example, such health monitoring may allow the control center 110 to alert the end user when an ozone system 120 is not functioning within specifications.

The I/O device 240 may be configured to provide a communication interface between the ozone data processor 205, the control center 110, the ozone systems 120, and other systems and devices. For example, the I/O device 240 may be configured to output data on bus 222 in response to data received from the input device 270 via signal 271. I/O device 240 may be configured to output data to the output device 280 via signal 281 in response to data received from CPU 210 transmitted to I/O device 240 via bus 222. I/O device 240 may be configured to communicate with the access point 225 and the ozone systems 120 via bus 222.

Input device 270 can be virtually any device to give input to ozone data processor 202. For example, a keyboard, keypad, light-pen, touch-screen, track-ball, or speech recognition unit, audio/video player, and the like could be used for input device 270. The output device 280 can be virtually any device to give output from ozone data processor 202 to a user thereof, e.g., any conventional display screen, printer, set of speakers along with their respective interface cards, i.e., video card and sound card, etc. For example, output device 280 may be configured to output display 101 and/or sound via speakers 262 connected to I/O device 240 and output device 280 via signal 261. Although shown separately from the input device 270, output device 280 and input device 270 could be combined. For example, a display screen with an integrated touch-screen, a display with an integrated keyboard, or a speech recognition unit combined with a text speech converter could be used.

Illustratively, the ozone end user locations 105 may include one or more ozone systems 120 that are in communication with the central controller 110. In one embodiment, a power line transceiver 250 is used to receive and transmit data from/to ozone system 120 coupled thereto via a power supply line 252. For example, as illustrated, the ozone systems 120M is in communication with the central control 110 via power line transceiver 250. The ozone end user locations 105 may also include the monitoring station 180. In one aspect, the monitoring station 180 may include a customer's processor 290 and a data monitor 292. The customer's processor 290 may be used for processing data for the customer's processes as is known, such as water treatment. The customer's processor 290 may also be configured to process data from ozone systems 120 and provide the control center 110 such data via the data monitor system 292. The data monitoring system 292 may be coupled to bus 222 via a communication signal 294 such as a telephone signal, wireless communication signal, optical signal, and network connection, as is known.

In one operational configuration, the control center 110 receives data associated with the dispensing of ozone gas at the ozone end user locations 105. For example, as illustrated in FIG. 2, the ozone systems 120 provide ozone data via wireless access point 225, power line transmitter 250, Internet 170, and communication signal 294 to the control center 110. The ozone program 232 determines the amount of ozone dispensed and calculates the cost thereof to the consumer. The control center 110 then generates an invoice (e.g., bill), for example, in response to the amount of ozone dispensed.

The ozone program 232 may also be used to control the amount of ozone dispensed. For example, if an agreement between the users of the ozone system 120L were to only dispense 80 grams of ozone per hour, the ozone program 232 would process the dispensing data for the ozone generator 120L and determine if ozone system 120L is producing ozone at that rate. If for example, the amount of ozone dispensed by ozone generator 120L was more than 80 grams per hour, then the ozone program 232 may control and/or instruct the ozone system 120 to provide less ozone until the ozone system 120L is within a predefined range about the 80 grams per hour ozone output.

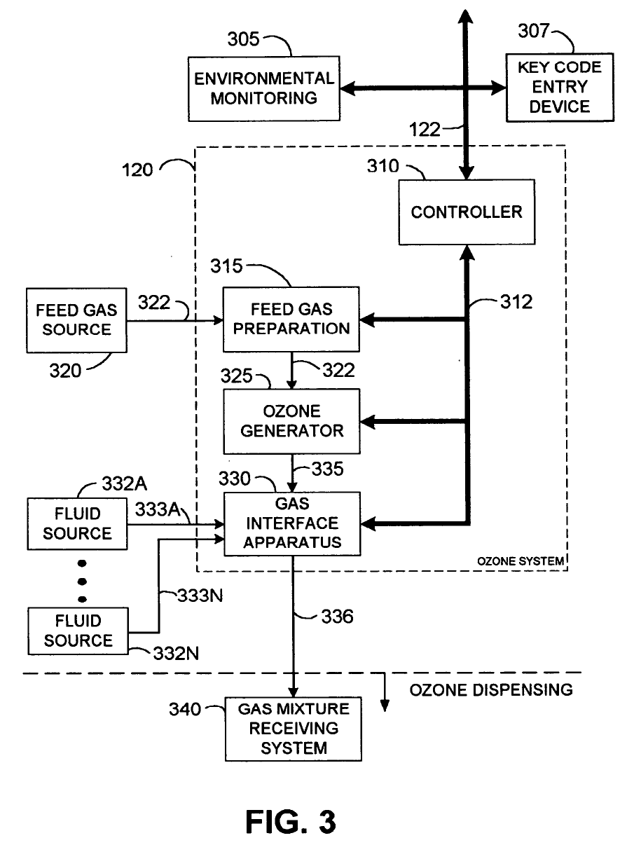

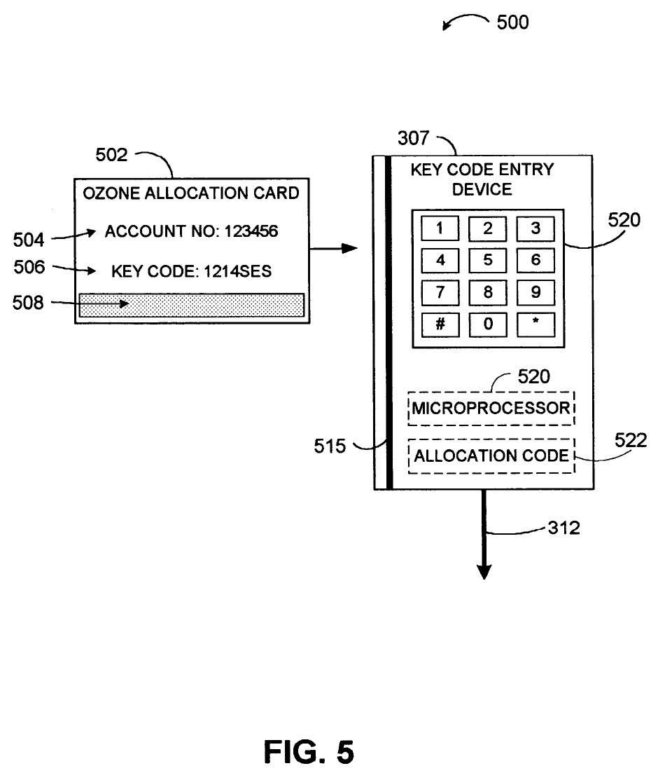

FIG. 3 is a high-level block diagram of an ozone system 120 in accordance with embodiments of the invention. In one configuration, the ozone system 120 includes a controller 310, a feed gas preparation apparatus 315, an ozone generator 325, and a gas interface apparatus 330. The controller 310 may be virtually any type of controller or processor capable of operating at least some portions of the ozone system 120. While the controller 310 is shown, it is optional as the control center 110 and/or the customer's processor 290 may be used to control the ozone system 120. The controller 310 is in communication with the feed gas preparation apparatus 315, the ozone generator 325, and the gas interface apparatus 320 via bus 312. The ozone system 120 may receive data via the communication link 122. In one embodiment, the ozone systems 120 may be controlled via a key code entry device 307. An embodiment of the key code entry/reader device 307 is described further below with respect to FIG. 5.

In one embodiment, a feed gas source 320 supplies a gas such as oxygen to the feed gas preparation apparatus 315 via gas line 322. The feed gas preparation apparatus 315 is configured to prepare and condition the feed gas for the ozone generator 325. The feed gas preparation apparatus 315 may dry the air or increase the oxygen concentration, for example, before being delivered to the ozone generator 325. The feed gas preparation apparatus 315 may be optional if the quality of the feed gas is sufficient. The ozone generator 325 then generates ozone gas as is known and outputs the ozone gas via gas line 335 to the gas interface apparatus 330. The gas interface apparatus 330 is coupled to one or more mixture sources 332A-N, such as a water supply being mixed with the ozone. The gas interface apparatus 330 mixes the ozone with a fluid such as air, water, or other type of fluid, and outputs the resultant mixture via mixture line 335 to a mixture receiving system 340 such as a wastewater treatment processing facility. In one configuration, the mixture may be composed of parasitic acid and water.

In one embodiment, the ozone system 120 may be linked to an environmental monitoring device 305 such as a thermostat, humidity measurement apparatus, atmospheric pressure measurement device, and other devices and systems used to monitor environmental conditions. Environmental data from environmental monitoring device 305 may be used to provide the control center 110, an end user, and/or third party with data pertaining to the operating environment of the ozone systems 120. Such environmental data may be used in the overall analysis and control of the amount, quality, and type of ozone dispensed by the ozone systems 120, the health of the ozone systems 120, and may provide other pertinent data that may be used to advantage.

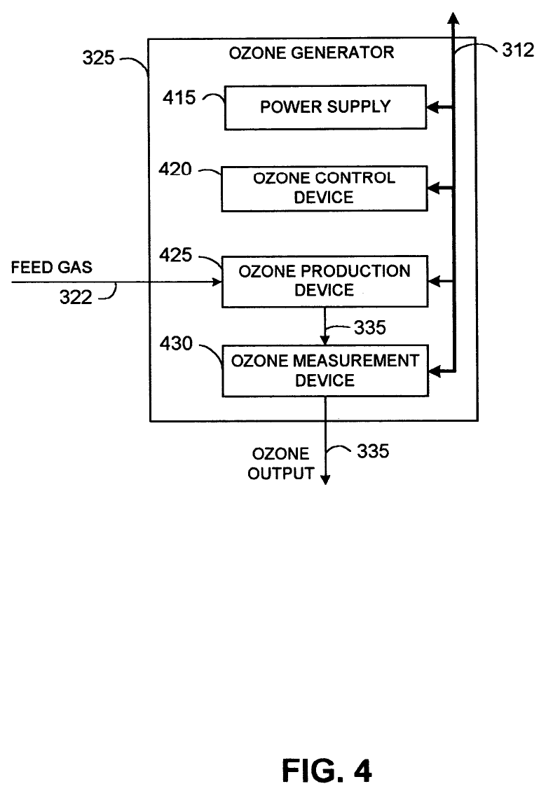

FIG. 4 is a high-level block diagram of an ozone generator 325 in accordance with embodiments of the invention. The ozone generator 325 may be virtually any type of ozone generation system. In one embodiment, the ozone generator 325 includes a power supply 410, an ozone control device 415, ozone production device 420, and an ozone measurement device 430. The power supply 410, the ozone control device 415, the ozone production device 420, and the ozone measurement device 430 communicate via bus 312.

The power supply 410 may be virtually any type of power supply system or device that may be used to advantage. The power supply 410 is optional as other external power sources may be used to power the ozone generator 325. The power supply 410 may be a standalone system and derive its power independently such as a solar power system, generator, etc., or may derive its electrical power from a common power supply source such as from a utility company and/or end user power bus as is known.

In one embodiment, the ozone control device 415 may be configured to control the amount of ozone gas dispensed. For example, the ozone control device 415 may be a processor, embodiments of which are described herein, that is configured to control the amount of ozone produced by the ozone production device 420. The ozone control device 415 is optional as other controllers such as the ozone data processor 202, customer processor 290, and the like, may be used to control the amount of ozone dispensed.

The ozone production device 420 may be virtually any type of ozone generation systems such as parallel plate ozone generator, spark gap ozone system, floating dielectric plate ozone generator, and other systems that provide ozone gas to advantage. An example of the ozone generator 325 is described in U.S. Pat. No. 5,512,254, entitled “Floating Dielectric Plate”, issued Apr. 30, 1996, herein incorporated by reference in its entirety. In one embodiment, the ozone production device 420 is a bus-mounted device that is rack mountable. For example, the ozone production device 420 may be a stackable ozone generation block that is used to provide scalable ozone output relative to the number of ozone production devices 420 that are linked together. The inventor contemplates a virtually limitless combination of interconnectable ozone production devices 420 to dispense ozone gas tailored to the end user's requirements.

The ozone measurement device 430 is configured to monitor one or more aspects of the ozone output such as quantity, quality, consistency, throughput variation, ozone concentration, and the like. The ozone measurement device 430 may be virtually any type of gas analyzer configured to monitor ozone gas parameters. The ozone measurement device 430 may also be formed from various interconnect parts such as a gas analyzer, mass flow meter, pressure sensor, flow regulator, and other components that may be used to advantage. It is understood that the ozone measurement device 430 are optional given that end users may employ their own gas analysis systems.

FIG. 5 is a high-level block diagram of an ozone allocation apparatus 500 in accordance with embodiments of the invention. As illustrated in FIG. 5, the present invention may be configured to utilize the key code entry/card reader device 307 to provide for attachment to a computer, or point-of-sale (POS) device, such as an electronic cash register, credit card system, or accounting software configured to accept financial transactions. The key code entry/card reader device 307 may be configured to receive data from the end user in the form of an allocation card 502. The allocation card 502 may include an account number 504 a specialized key code 506, and a magnetic strip 508 that contains the account number, key code, and may include other data pertinent to the end user and/or ozone system 120.

In operation, a user inserts the allocation card 502 into the card reader slot 515. An ozone allocation code 522, known to the control center 110 and to the ozone system 120, is generated by the microprocessor 520 in response to data entered and is provided to the ozone system 120 via signal 312. This allocation code 522 may then be used to authorize the dispensment of ozone as described herein. The allocation code 522 may be generated to allow the ozone system 120 being controlled to dispense ozone via a time period, quantity, etc. For example, the allocation code 522 may only allow an end user to use the ozone system 120 for a specified period of time. The allocation code 522 may also be used to allocate a specified amount of ozone dispensed. The inventor contemplates that the allocation code 522 may be transmitted to an end user for input via keypad 520 and/or may be transmitted via allocation card 502 via magnetic strip 508 or by the user of the card entering data from the card directly into the keypad 520. It is contemplated that the account number 504, key code 506, may be entered, individually, or in combination via keypad 520 to generate the ozone allocation code 522. To alleviate misuse, it is contemplated that the ozone allocation code may be used to control the dispensment of ozone for one or more ozone systems 120 associated with the account number on the allocation card 520 or may be configured to only work with one ozone system 120.

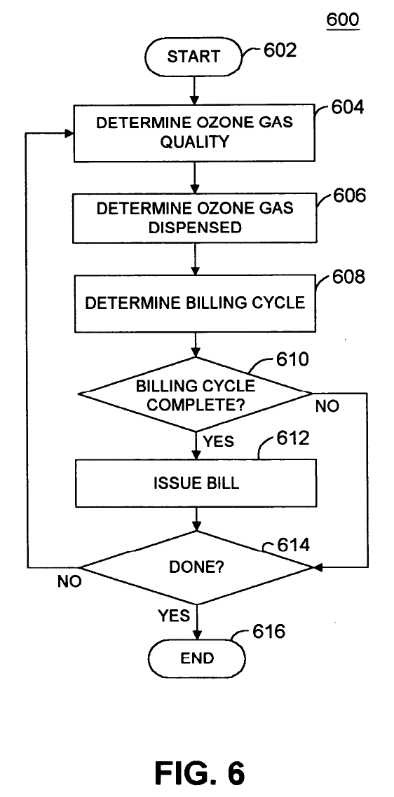

FIG. 6 is a high-level flow diagram of a method 600 for billing customers for ozone dispensed in accordance with embodiments of the invention. Method 600 may be entered into at 602 when for example, the ozone program 232 is activated. At 604 method 600 determines the ozone gas quality. For example, the ozone gas may be configured to be at a concentration level of 3% when dispensed, the method 600 would determine if the ozone gas being dispensed is at the 3% level or within an acceptable range thereof. In one operational example, referring now to FIG. 2, method 600 may be used to control ozone system 120 to dispense ozone at a given weight per hour (e.g., 13 grams per hour) of ozone with feed gas oxygen having a particular flow rate (e.g., 10 Standard Cubic Feet Per Hour (SCFH).

Referring back to FIG. 6, at 606, the amount of ozone gas dispensed is measured. The measurement may be in the form of ozone output in volume, weight, pressure, and the like, for example, grams of ozone gas per hour. For example, method 600 may be used to for example measure the amount of ozone dispensed using ozone measurement device 430 (See FIG. 4).

A billing cycle is determined at 608. If at 610, the billing cycle is completed, the method 600 proceeds to 612 and issues a bill (e.g., invoice, payment slip, etc.) to the end user with respect to the amount of ozone dispensed. If however, at 610, the billing cycle is not finished, then the method 600 goes to 614. At 614, if the ozone dispensing and billing process is completed, method 600 proceeds to 616 and ends. If however, if the ozone dispensing and billing process is not complete then method 600 returns to 604.

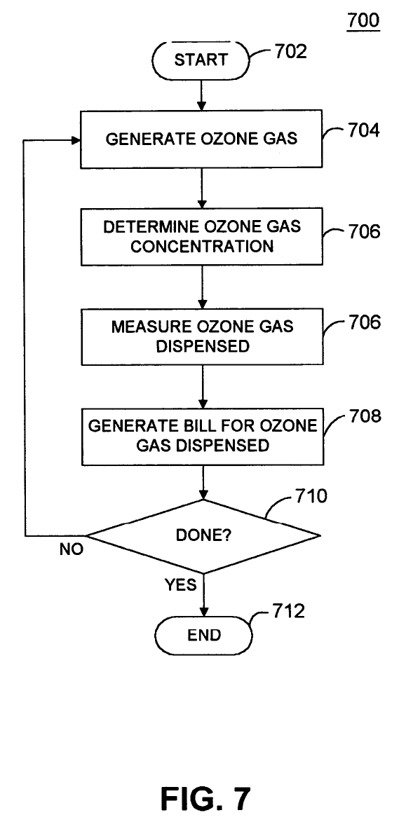

FIG. 7 is a high-level flow diagram of a method 700 for dispensing ozone in accordance with embodiments of the invention. Method 700 may be entered into at 702 when for example, ozone program 232 is activated. At 704, ozone gas is generated. For example, ozone gas may be generated by ozone generator 325 (See FIG. 3). At 706, the ozone gas concentration is determined. In one example, ozone concentration may be relative the input supply gas such as oxygen, and/or may be the amount of ozone gas in a mixture of ozone gas and other fluid. The mixture may be for example, the concentration of ozone gas dissolved in water. At 706, the method 700 determines the amount of ozone gas dispensed. In one case, the efficiency of the ozone gas dispensment may be determined by comparing the ozone generation to the amount of ozone gas dispensed. The method 700 then generates a bill for the amount of ozone gas dispensed and/or generated at 708 to be sent to the end user and/or third party paying for the ozone dispensed. In one embodiment, the bill may be modified by method 700 with respect to the quality of the ozone dispensed. For example, if an end user expects an ozone system 120 to dispense 13 grams of ozone per hour at a concentration of 3%, and such ozone system dispenses ozone at 2.5%, the bill may be modified to accommodate the drop in ozone concentration. At 708, if the ozone dispensing and billing process is completed, method 700 proceeds to 712 and ends. If however, if the ozone dispensing and billing process is not complete then method 700 returns to 704.

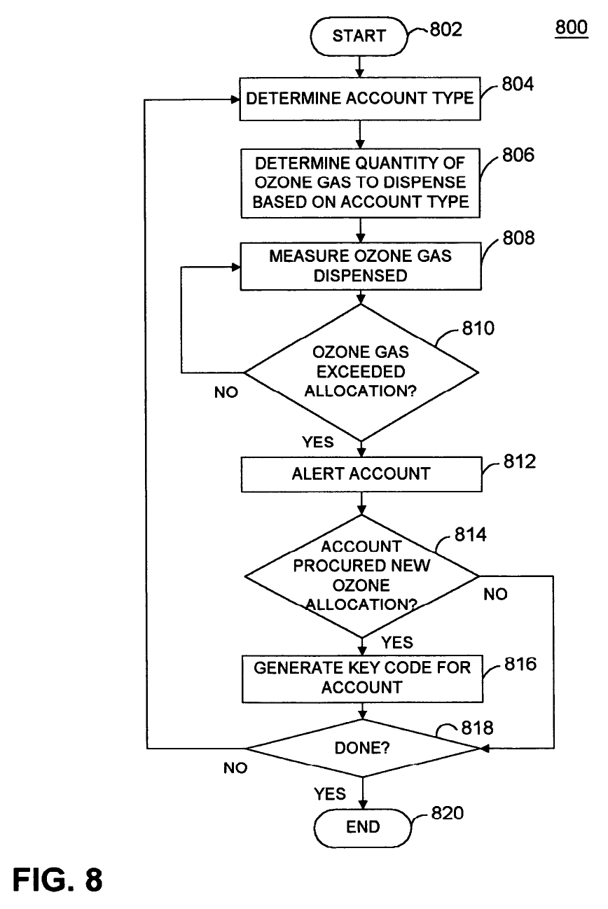

FIG. 8 is a high-level flow diagram of a method 800 for allocating ozone dispensement in accordance with embodiments of the invention. Method 800 may be entered into at 802 when for example, ozone program 232 is activated. At 804, the account type is determined. For example, the account type may be based on quantity dispensed, the time period, the allotment of ozone, etc. Once the account type has been determined, at 806 method 800 determines the quantity of ozone gas to allocate based on account type. For example, for an account type that procures ozone gas based on weight per hour, the method 800 would set the amount of ozone allocated to a specified amount in weight per hour.

At 808, the method 800 determines the amount of ozone dispensed. For example, an ozone measurement device configured to measure the amount of ozone concentration by weight may measure the amount of ozone dispensed. The ozone measurement may also be determined by the amount of ozone gas within a given mixture of one or more fluids such as water. The amount of ozone dispensed is then compared to the allotment amount determined at 806. If the actual allotment exceeds the allotment amount, then the method 800 alerts the account. In one embodiment, the ozone being dispensed until the account procures a new allotment amount. In alternate embodiments, the ozone gas may continue to be dispensed with a bill being sent to the account when the amount of ozone gas dispensed meets or exceeds the allotment amount. In this case, the cost for the ozone may vary with each allotment. If the allotment amount has not been met or exceeded, then method 800 returns to 808.

At 812, the method 800 checks if the account has procured a new allotment amount. If not, the method proceeds to 818. In one embodiment, if the account has procured another allotment amount of ozone, a new key code is generated in response thereof. The key code may be used to set an ozone system such as ozone system 120 to the new allotment. If at 818, the method is finished, for example, the allotment has run out, and no ozone is to be generated, the method 800 proceeds to 820 and ends. If however, the method 800 is not done, e.g., the account renews the allotment amount, the method 800 returns to 804.

While the foregoing is directed to embodiments of the present invention, other and further embodiments of the invention may be devised without departing from the basic scope thereof, and the scope thereof is determined by the claims that follow.

1. An ozone gas dispensing system, comprising:
one or more ozone systems, each deployed at one or more ozone dispensing locations;
an ozone measurement system configured to generate ozone dispensing data in response to the amount of ozone dispensed by at least one of the one or more ozone systems;
a controller configured to process the ozone dispensing data and control the one or more ozone systems; and
a communication system configured to allow a controller, the ozone measurement system, and the one or more ozone systems to communicate via one or more communication links.

2. The ozone gas dispensing system of claim 1, wherein the ozone system comprises a feed gas preparation device.

3. The ozone gas dispensing system of claim 1, wherein the ozone system comprises a floating dielectric plate ozone generator.

4. The ozone gas dispensing system of claim 1, wherein the ozone system comprises a gas interface apparatus.

5. The ozone gas dispensing system of claim 1, wherein the ozone system comprises a key code data entry device.

6. The ozone gas dispensing system of claim 1, wherein the ozone system comprises an environmental monitoring system configured to monitor environmental conditions related to the surrounding environment of the ozone gas dispensing system.

7. An ozone gas dispensing system, comprising:
an ozone generator;
an ozone measurement device coupled to an ozone output of the ozone generator;
a communication apparatus configured to facilitate communication between the ozone gas dispensing apparatus and a control center; and
an ozone control device configured to control the amount of ozone dispensed in response to data received from the control center.

8. The ozone gas dispensing system of claim 7, wherein the ozone generator comprises a flat plate air-cooled ozone generation device.

9. The ozone gas dispensing system of claim 7, wherein the ozone measurement device comprises an ozone concentration analyzer.

10. The ozone gas dispensing system of claim 7, wherein the ozone measurement device comprises an ozone quality analyzer.

11. The ozone gas dispensing system of claim 10, wherein the ozone measurement device comprises a gas analyzer configured to measure the amount of ozone dissolved in a fluid mixture.

12. The ozone gas dispensing system of claim 10, wherein the ozone measurement device comprises a gas analyzer configured to measure the ozone concentration.

13. The ozone gas dispensing system of claim 7, further comprising a data key/card reader apparatus.

14. The ozone gas dispensing system of claim 7, wherein the ozone control device comprises a controller and program wherein the program is configured to;
analyze the amount of ozone consumed; and
determine a cost for the amount of ozone consumed.

15. A method of dispensing ozone gas, comprising:
measuring the amount of ozone gas dispensed;
determining the monetary cost for the amount of ozone gas dispensed; and
generating a monetary cost bill to issue to an end user of the ozone gas.

16. The method of claim 15, wherein measuring the amount of ozone dispensed comprises, measuring the flow of ozone gas over a predefined time.

17. The method of claim 15, further comprising determining the allotment of ozone gas to be dispensed to the end user.

18. The method of claim 15, wherein determining the monetary cost comprises determining the contractual cost of the ozone dispensed.

19. The method of claim 15, wherein measuring the amount of ozone gas dispensed comprises determining the quality of the ozone dispensed.

20. The method of claim 15, wherein measuring the amount of ozone gas dispensed comprises generating a key code associated with an amount of zone to be dispensed.
